(19) United States
(12) Patent Application Publication
(10) Pub. No.: US 2024/0085511 A1
(43) Pub. Date: Mar. 14, 2024

(54) SYSTEM AND METHOD FOR DETERMINING UWB BEACON POLE LOCATIONS FOR EXTENDED SERVICE AREAS OF A ROBOT

(71) Applicant: Samsung Electronics Co., Ltd., Suwon-si (KR)

(72) Inventors: Indranil Sinharoy, Richardson, TX (US); Yuming Zhu, Plano, TX (US); Songwei Li, McKinney, TX (US)

(21) Appl. No.: 18/149,001

(22) Filed: Dec. 30, 2022

Related U.S. Application Data
(60) Provisional application No. 63/405,228, filed on Sep. 9, 2022.

(51) Int. Cl. G01S 1/68; G01S 1/04; G01S 5/02; G05D 1/02

(52) U.S. Cl. CPC G01S 1/68; G01S 1/0428; G01S 5/0226; G05D 1/028; G05D 2201/0208

(57) ABSTRACT

A method includes identifying a first anchor of a plurality of anchors as an initiator and identifying multiple second anchors of the plurality of anchors as multiple responders, the plurality of anchors located in a service area to be traversed by a robot. The method also includes sending, to the initiator and the responders via a wireless side-link, ranging information and a command to start ultra-wideband (UWB) ranging. The method also includes receiving, from the initiator via the wireless side-link, pair-wise range measurements representing UWB range measurements between the initiator and the responders. The method also includes generating initial location values for the initiator and the responders based on the pair-wise range measurements and one or more geometric constraints imposed on the initiator and the responders. The method also includes estimating 3D coordinates of the initiator and the responders using the initial location values.

### CROSS-REFERENCE TO RELATED APPLICATIONS AND CLAIM OF PRIORITY

The present application claims priority to U.S. Provisional Patent Application No. 63/405,228 filed on Sep. 9, 2022. The content of the above-identified patent document is incorporated herein by reference.

### TECHNICAL FIELD

The present disclosure relates generally to wireless robot systems and, more specifically, the present disclosure relates to a system and method for determining ultra-wideband (UWB) beacon pole locations for extended service areas of a robot.

### BACKGROUND

Autonomous service robots, such as vacuum cleaners and lawn mowers, have gained popularity in home and business environments in recent years. Early generations of such robots used simple controls, such as moving until the robot bumps into a wall or another obstacle, and then turning. For some robots such as lawn mowers, the bump-and-turn technique can be a dangerous strategy, as it might cause damage to property and/or the robot itself. Thus, additional sensors (e.g., camera, grass sensor, etc.) or infrastructure (e.g., a buried boundary wire with DC voltage) may be used to minimize or avoid dangerous situations.

### SUMMARY

The present disclosure relates to wireless robot systems and, more specifically, the present disclosure relates to a system and method for determining UWB beacon pole locations for extended service areas of a robot.

In one embodiment, a method includes identifying a first anchor of a plurality of anchors as an initiator and identifying multiple second anchors of the plurality of anchors as multiple responders, the plurality of anchors located in a service area to be traversed by a robot. The method also includes sending, to the initiator and the responders via a wireless side-link, ranging information and a command to start ultra-wideband (UWB) ranging. The method also includes receiving, from the initiator via the wireless side-link, pair-wise range measurements representing UWB range measurements between the initiator and the responders. The method also includes generating initial location values for the initiator and the responders based on the pair-wise range measurements and one or more geometric constraints imposed on the initiator and the responders. The method also includes estimating 3D coordinates of the initiator and the responders using the initial location values.

In another embodiment, a device includes a transceiver and a processor operably connected to the transceiver. The processor is configured to: identify a first anchor of a plurality of anchors as an initiator and identify multiple second anchors of the plurality of anchors as multiple responders, the plurality of anchors located in a service area to be traversed by a robot; send, to the initiator and the responders via a wireless side-link, ranging information and a command to start UWB ranging; receive, from the initiator via the wireless side-link, pair-wise range measurements representing UWB range measurements between the initiator and the responders; generate initial location values for the initiator and the responders based on the pair-wise range measurements and one or more geometric constraints imposed on the initiator and the responders; and estimate 3D coordinates of the initiator and the responders using the initial location values.

In yet another embodiment, a non-transitory computer readable medium includes program code that, when executed by a processor of a device, causes the device to: identify a first anchor of a plurality of anchors as an initiator and identify multiple second anchors of the plurality of anchors as multiple responders, the plurality of anchors located in a service area to be traversed by a robot; send, to the initiator and the responders via a wireless side-link, ranging information and a command to start UWB ranging; receive, from the initiator via the wireless side-link, pair-wise range measurements representing UWB range measurements between the initiator and the responders; generate initial location values for the initiator and the responders based on the pair-wise range measurements and one or more geometric constraints imposed on the initiator and the responders; and estimate 3D coordinates of the initiator and the responders using the initial location values.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system according to embodiments of this disclosure;

FIG. 2 illustrates an example electronic device according to embodiments of this disclosure;

FIG. 3 illustrates an example system in which UWB beacon pole locations can be determined for extended service areas of a robot according to embodiments of the present disclosure;

FIGS. 4A through 4C illustrate different configurations for an anchor according to embodiments of the present disclosure;

FIG. 5 illustrates an example diagram of a UWB based robot according to embodiments of the present disclosure;

FIG. 6 illustrates an example user interface for discovering and connecting system devices according to embodiments of the present disclosure;

FIG. 7 illustrates a diagram showing localization of a first group of four anchors according to embodiments of the present disclosure;

FIGS. 8A and 8B illustrate a flowchart of an example process for auto-positioning of the first four anchors, according to embodiments of the present disclosure;

FIG. 9 illustrates an example local reference frame using the first four anchors according to embodiments of the present disclosure;

FIG. 10 illustrates an example initialization strategy for solving for the coordinates of the first four anchors according to embodiments of the present disclosure;

FIGS. 11A and 11B illustrate example user interfaces showing activation of auto-positioning by the user according to embodiments of the present disclosure;

FIG. 12 illustrates an example user interface that warns the user about a detected NLoS condition during auto-positioning, according to embodiments of the present disclosure;

FIG. 13A through 13D illustrate an example of anchor auto-positioning of more than four anchors near a building according to embodiments of the present disclosure;

FIGS. 14A and 14B illustrate a flowchart of an example process for determining locations of additional anchors according to embodiments of the present disclosure;

FIG. 15 illustrates an example initialization strategy according to embodiments of the present disclosure;

FIG. 16 illustrates an example of auto-positioning according to embodiments of the present disclosure;

FIGS. 17A and 17B illustrate an example progressive estimation of anchor locations in complex scenarios using the robot, according to embodiments of the present disclosure; and

FIG. 18 illustrates a flow chart of a method for determining UWB beacon pole locations for extended service areas of a robot according to embodiments of the present disclosure.

### DETAILED DESCRIPTION

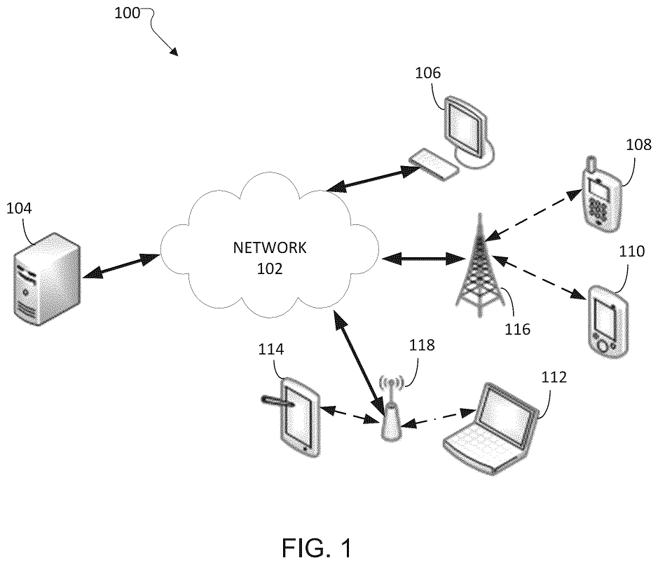

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

FIG. 1 illustrates an example communication system 100 in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-114. The client devices 106-114 may be, for example, a smartphone (such as a UE), a tablet computer, a laptop, a personal computer, a wearable device, a head mounted display, or the like. The server 104 can represent one or more servers. Each server 104 includes any suitable computing or processing device that can provide computing services for one or more client devices, such as the client devices 106-114. Each server 104 could, for example, include one or more processing devices, one or more memories storing instructions and data, and one or more network interfaces facilitating communication over the network 102.

Each of the client devices 106-114 represent any suitable computing or processing device that interacts with at least one server (such as the server 104) or other computing device(s) over the network 102. The client devices 106-114 include a desktop computer 106, a mobile telephone or mobile device 108 (such as a smartphone), a PDA 110, a laptop computer 112, and a tablet computer 114. However, any other or additional client devices could be used in the communication system 100, such as wearable devices. Smartphones represent a class of mobile devices 108 that are handheld devices with mobile operating systems and integrated mobile broadband cellular network connections for voice, short message service (SMS), and Internet data communications. In certain embodiments, any of the client devices 106-114 can perform processes for determining UWB beacon pole locations for extended service areas of a robot.

In this example, some client devices 108-114 communicate indirectly with the network 102. For example, the mobile device 108 and PDA 110 communicate via one or more base stations 116, such as cellular base stations or eNodeBs (eNBs) or gNodeBs (gNBs). Also, the laptop computer 112 and the tablet computer 114 communicate via one or more wireless access points 118, such as IEEE 802.11 wireless access points. Note that these are for illustration only and that each of the client devices 106-114 could communicate directly with the network 102 or indirectly with the network 102 via any suitable intermediate device(s) or network(s). In certain embodiments, any of the client devices 106-114 transmit information securely and efficiently to another device, such as, for example, the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

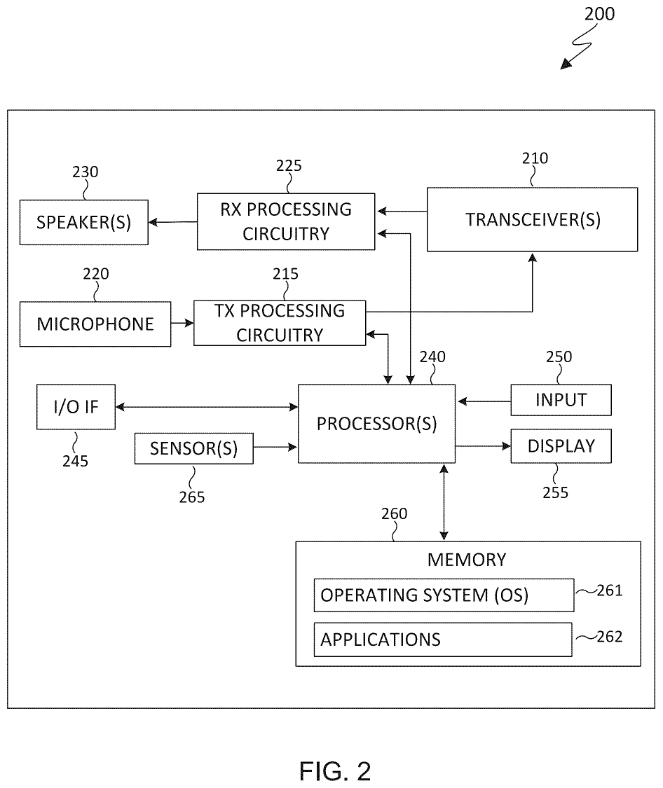

FIG. 2 illustrates an example electronic device in accordance with an embodiment of this disclosure. In particular, FIG. 2 illustrates an example electronic device 200, and the electronic device 200 could represent the server 104 or one or more of the client devices 106-114 in FIG. 1. The electronic device 200 can be a mobile communication device, such as, for example, a UE, a mobile station, a subscriber station, a wireless terminal, a desktop computer (similar to the desktop computer 106 of FIG. 1), a portable electronic device (similar to the mobile device 108, the PDA 110, the laptop computer 112, or the tablet computer 114 of FIG. 1), a robot, and the like.

As shown in FIG. 2, the electronic device 200 includes transceiver(s) 210, transmit (TX) processing circuitry 215, a microphone 220, and receive (RX) processing circuitry 225. The transceiver(s) 210 can include, for example, a RF transceiver, a BLUETOOTH transceiver, a WiFi transceiver, a ZIGBEE transceiver, an infrared transceiver, and various other wireless communication signals. The electronic device 200 also includes a speaker 230, a processor 240, an input/output (I/O) interface (IF) 245, an input 250, a display 255, a memory 260, and a sensor 265. The memory 260 includes an operating system (OS) 261, and one or more applications 262.

The transceiver(s) 210 can include an antenna array including numerous antennas. For example, the transceiver(s) 210 can be equipped with multiple antenna elements. There can also be one or more antenna modules fitted on the terminal where each module can have one or more antenna elements. The antennas of the antenna array can include a radiating element composed of a conductive material or a conductive pattern formed in or on a substrate. The transceiver(s) 210 transmit and receive a signal or power to or from the electronic device 200. The transceiver(s) 210 receives an incoming signal transmitted from an access point (such as a base station, WiFi router, or BLUETOOTH device) or other device of the network 102 (such as a WiFi, BLUETOOTH, cellular, 5G, LTE, LTE-A, WiMAX, or any other type of wireless network). The transceiver(s) 210 down-converts the incoming RF signal to generate an intermediate frequency or baseband signal. The intermediate frequency or baseband signal is sent to the RX processing circuitry 225 that generates a processed baseband signal by filtering, decoding, and/or digitizing the baseband or intermediate frequency signal. The RX processing circuitry 225 transmits the processed baseband signal to the speaker 230 (such as for voice data) or to the processor 240 for further processing (such as for web browsing data).

The TX processing circuitry 215 receives analog or digital voice data from the microphone 220 or other outgoing baseband data from the processor 240. The outgoing baseband data can include web data, e-mail, or interactive video game data. The TX processing circuitry 215 encodes, multiplexes, and/or digitizes the outgoing baseband data to generate a processed baseband or intermediate frequency signal. The transceiver(s) 210 receives the outgoing processed baseband or intermediate frequency signal from the TX processing circuitry 215 and up-converts the baseband or intermediate frequency signal to a signal that is transmitted.

The processor 240 can include one or more processors or other processing devices. The processor 240 can execute instructions that are stored in the memory 260, such as the OS 261 in order to control the overall operation of the electronic device 200. For example, the processor 240 could control the reception of forward channel signals and the transmission of reverse channel signals by the transceiver(s) 210, the RX processing circuitry 225, and the TX processing circuitry 215 in accordance with well-known principles. The processor 240 can include any suitable number(s) and type(s) of processors or other devices in any suitable arrangement. For example, in certain embodiments, the processor 240 includes at least one microprocessor or microcontroller. Example types of processor 240 include microprocessors, microcontrollers, digital signal processors, field programmable gate arrays, application specific integrated circuits, and discrete circuitry. In certain embodiments, the processor 240 can include a neural network.

The processor 240 is also capable of executing other processes and programs resident in the memory 260, such as operations that receive and store data. The processor 240 can move data into or out of the memory 260 as required by an executing process. In certain embodiments, the processor 240 is configured to execute the one or more applications 262 based on the OS 261 or in response to signals received from external source(s) or an operator. For example, applications 262 can include a multimedia player (such as a music player or a video player), a phone calling application, a virtual personal assistant, and the like.

The processor 240 is also coupled to the I/O interface 245 that provides the electronic device 200 with the ability to connect to other devices, such as client devices 106-114. The I/O interface 245 is the communication path between these accessories and the processor 240.

The processor 240 is also coupled to the input 250 and the display 255. The operator of the electronic device 200 can use the input 250 to enter data or inputs into the electronic device 200. The input 250 can be a keyboard, touchscreen, mouse, track ball, voice input, or other device capable of acting as a user interface to allow a user to interact with the electronic device 200. For example, the input 250 can include voice recognition processing, thereby allowing a user to input a voice command. In another example, the input 250 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 250 can be associated with the sensor(s) 265, a camera, and the like, which provide additional inputs to the processor 240. The input 250 can also include a control circuit. In the capacitive scheme, the input 250 can recognize touch or proximity.

The display 255 can be a liquid crystal display (LCD), light-emitting diode (LED) display, organic LED (OLED), active matrix OLED (AMOLED), or other display capable of rendering text and/or graphics, such as from websites, videos, games, images, and the like. The display 255 can be a singular display screen or multiple display screens capable of creating a stereoscopic display. In certain embodiments, the display 255 is a heads-up display (HUD).

The memory 260 is coupled to the processor 240. Part of the memory 260 could include a RAM, and another part of the memory 260 could include a Flash memory or other ROM. The memory 260 can include persistent storage (not shown) that represents any structure(s) capable of storing and facilitating retrieval of information (such as data, program code, and/or other suitable information). The memory 260 can contain one or more components or devices supporting longer-term storage of data, such as a read only memory, hard drive, Flash memory, or optical disc.

The electronic device 200 further includes one or more sensors 265 that can meter a physical quantity or detect an activation state of the electronic device 200 and convert metered or detected information into an electrical signal. For example, the sensor 265 can include one or more buttons for touch input, a camera, a gesture sensor, optical sensors, cameras, one or more inertial measurement units (IMUs), such as a gyroscope or gyro sensor, and an accelerometer. The sensor 265 can also include an air pressure sensor, a magnetic sensor or magnetometer, a grip sensor, a proximity sensor, an ambient light sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 265 can further include control circuits for controlling any of the sensors included therein. Any of these sensor(s) 265 may be located within the electronic device 200 or within a secondary device operably connected to the electronic device 200.

Although FIG. 2 illustrates one example of electronic device 200, various changes can be made to FIG. 2. For example, various components in FIG. 2 can be combined, further subdivided, or omitted and additional components can be added according to particular needs. As a particular example, the processor 240 can be divided into multiple processors, such as one or more central processing units (CPUs), one or more graphics processing units (GPUs), one or more neural networks, and the like. Also, while FIG. 2 illustrates the electronic device 200 configured as a mobile telephone, tablet, or smartphone, the electronic device 200 can be configured to operate as other types of mobile or stationary devices.

As discussed above, mobile autonomous service robots such as robot lawn mowers (RLMs), robot vacuum cleaners, robot butlers, and the like, are increasingly being deployed at homes, businesses, and industrial complex environments. Such mobile robots depend on the ability to sense their environments and localize themselves within their environment in order to complete their intended tasks efficiently. For example, a RLM may need to know the area and perimeter of its service area (which could include multiple mowing zones), keep-out zones, and pass-through zones. In order to operate autonomously, the RLM needs to be aware of its own location at any instance of time within the service area so that it can perform its job (e.g., mowing a lawn) in a pre-planned way depending on the shape of the zones in the service area. Additionally, the RLM needs to be aware of the boundaries of the lawn so that the RLM stays within the mowable (permitted) zones. Finally, the RLM may need to be aware of the location of the charging station so that it can move to the charging station at an appropriate time before it runs out of power.

Some techniques have been introduced for generating a blueprint of the robot's environment and for localizing the robot in its environment. Some of these techniques include UWB-based localization, which is generally low cost and provides centimeter-level position accuracy both outdoors and indoors. Some UWB-based localization techniques rely on distance measurements between a set of nodes with known positions and the node whose position is to be estimated. Such localization problems from distance measurements are known as a multilateration problem.

UWB-based localization systems typically include two groups of UWB sensors (or nodes). The first group of UWB sensors—referred to as anchors—are installed at fixed locations throughout the service area. The second set of one or more UWB sensors, referred to as tags, could be installed on the mobile robot whose location is to be determined with respect to the known locations of the anchors. To generate unique reference about the localization of a tag, the system needs three or more anchors with known positions (i.e., trilateration).

Although the anchors could be placed at pre-determined (known) locations, often the 2D or 3D positions of these anchors is determined through a process known as anchor self-calibration, anchor self-localization, or anchor auto-positioning. Anchor self-localization allows the system to be flexible such that the anchors could be placed around the service area without any special restrictions. Furthermore, this flexibility allows the user to install additional anchors to the system to extend the service area.

In UWB ranging, the distance between two anchors can be obtained by passing specific message frames between the two anchors. One of the anchors, designated as the initiator, sends a message to the other anchor designated as the responder. The responder sends a response frame after a certain time, which the initiator receives and computes the round-trip time of the message. The distance between the two anchors can then be inferred from the round-trip time and the speed of the RF signal (taken as equal to the speed of light).

To generate the blueprint of the robot's environment, the system needs to accurately determine the 2D or 3D positions of the anchors. Furthermore, the accurate determination of the anchor locations is needed for proper localization of the robot in its environment. Finally, the system should allow the user to extend the service area if and when needed, thus allowing easy addition of new anchors to the system and determining the positions of the new anchors based on the known positions of the existing anchors.

When there are no obstacles, such as walls, trees, or other objects, between two ranging nodes, there is a direct path for the radio signal to travel from one node to the other, resulting in unambiguous determination of time of the received signal at the receiving node. This condition is called a Line-of-Sight (LoS) condition. Conversely, when there are obstacles between the two ranging nodes, the UWB signals get reflected off one or more surfaces, resulting in multiple paths for propagation of the signal. In such conditions, called Non-Line-of-Sight (NLoS), it becomes difficult to accurately determine the time of the received signal at the receiver, resulting in the loss in accuracy of ranging measurements. Moreover, the strength of the signal reduces as it travels from the transmitting node to the receiving node due to propagation path losses. The transmitter-to-receiver distance and the signal frequency are two major factors contributing to the propagation path loss.

Consequently, the accuracy of UWB ranging and the subsequent tag localization estimate are influenced by the received signal strength (measured by RSSI) and the LoS/NLoS conditions. Therefore, robot localization can be adversely impacted if the anchors are not installed suitably (i.e., disregarding the conditions that could result in poor range measurements).

To address these and other issues, this disclosure provides systems and methods for determining UWB beacon pole locations for extended service areas of a robot. As described in more detail below, the disclosed embodiments provide methods for progressive automatic determination of UWB anchor positions for robot systems. Such methods can be used in the presence of NLoS conditions where there are obstacles between multiple anchor-anchor pairs. Such methods can also be used to extend the total service area range beyond the specified working range of the UWB anchors. In some embodiments, the robot itself may be used along with at least two other anchors for determining the position of a new anchor in the presence of severe NLoS conditions.

The disclosed embodiments also provide methods for initialization of unknown parameters for solving a non-linear least squares optimization problem, which can be used for determining unknown anchor locations. The disclosed methods leverage the geometric constraints imposed on the anchor order and arrangement of the first few anchors. This initialization strategy ensures that the optimization problem converges swiftly to a desirable solution. In addition, the disclosed embodiments provide methods to determine if one or more anchors are in a severe NLoS condition and then to notify the user to move the affected anchor to a new position.

Note that while some of the embodiments discussed below are described in the context of robotic lawn mowers capable of mowing grass in a service area, these are merely examples. It will be understood that the principles of this disclosure may be implemented in any number of other suitable contexts or systems, including other home or industrial automation systems.

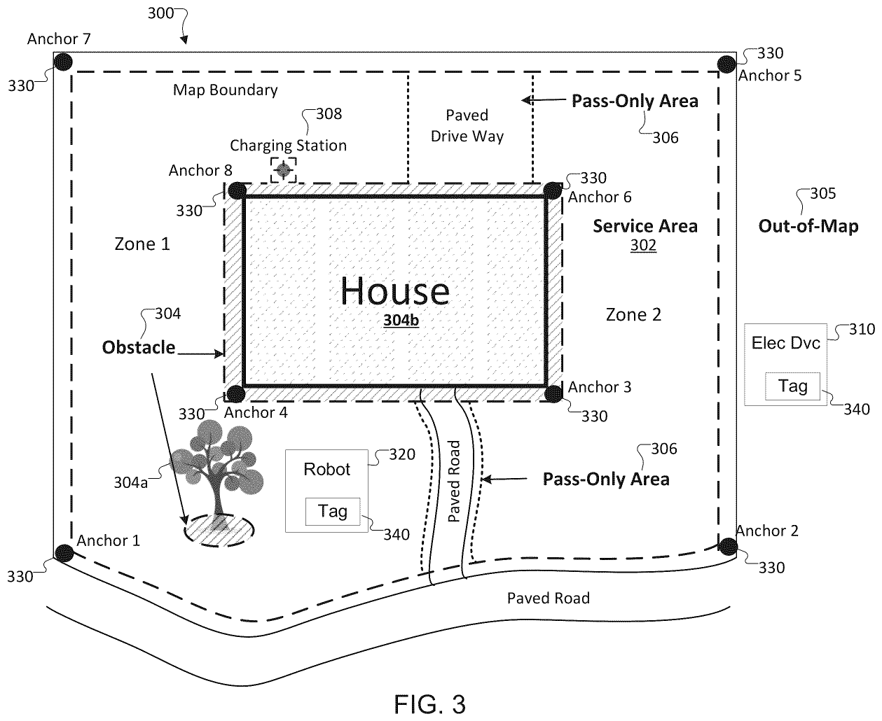

FIG. 3 illustrates an example system 300 in which UWB beacon pole locations can be determined for extended service areas of a robot according to embodiments of the present disclosure. For ease of explanation, the system 300 will be described as including one or more components of the communication system 100 of FIG. 1, such as the client devices 106-114; however, the system 300 could be implemented using any other suitable device or system. The embodiment of the system 300 shown in FIG. 3 is for illustration only. Other embodiments of the system 300 could be used without departing from the scope of this disclosure.

As shown in FIG. 3, the system 300 includes a service area 302, an electronic device 310, a robot 320, and multiple anchors 330.

The service area 302 is a geographical area in which the robot 320 moves while performing one or more functions. In the system 300, the service area 302 represents a lawn that is to be mowed by the robot 320. Excluded from the service area 302 are one or more obstacles 304 (such as trees 304a, a house 304b, a sculpture, a pool, a fountain, and the like) and an out-of-map area 305. The robot 320 is trained to avoid entering (or trying to enter) the out-of-map area 305 and the areas occupied by the obstacles 304. The service area 302 can also include one or more pass-only areas 306, which are areas that are safe for the robot 320 to pass through but should not perform service. The pass-only areas 306 could include a driveway or sidewalk in the service area 302. If the service area 302 is separated by the pass-only areas 306 into different zones, the pass-only areas 306 could link the zones together and create a viable path.

The electronic device 310 is a wireless handheld device that can be used for teaching the boundaries of the service area 302 to the system 300 and determining locations of the anchors 330. In some embodiments, the electronic device 310 is a personal consumer device, such as a smart phone or tablet. The electronic device 310 may represent (or be represented by) one of the client devices 106-114.

The robot 320 is a wireless communication-enabled device capable of moving around the service area 302 and performing one or more functions, such as mowing grass, spraying fertilizer, and the like. As described earlier, the robot 320 can be a lawn-mowing robot, although this is merely one example, and other types of robots are within the scope of this disclosure.

The anchors 330 include UWB sensors (or other types of RF sensors) and are placed in fixed locations throughout the service area 302 to provide reference for localization and for determining the service area 302. To generate unique reference about the localization, the system 300 may include three or more anchors 330, as described in greater detail below.

Each of the electronic device 310 and the robot 320 can include one or more tags 340. The tags 340 are UWB sensors that are installed in (or otherwise connected to) the electronic device 310 and the robot 320 and enable UWB communication with the anchors 330. In UWB based localization, the tags 340 are used to localize the electronic device 310 or the robot 320 in the environment using the reference information provided by the anchors 330. In some embodiments, the electronic device 310 may not include a built-in tag 340 (such as when the electronic device 310 is a smart phone or tablet that is not configured for UWB communication).

In some embodiments, the system 300 is capable of generating a map of the service area 302 based on obtained location information. In some embodiments, the service area 302 can be annotated with different categories, such as one or more keep-out areas (i.e., the obstacles 304) and one or more pass-only areas 306. The map can also identify the location of a charging station 308, to which the robot 320 can return for charging.

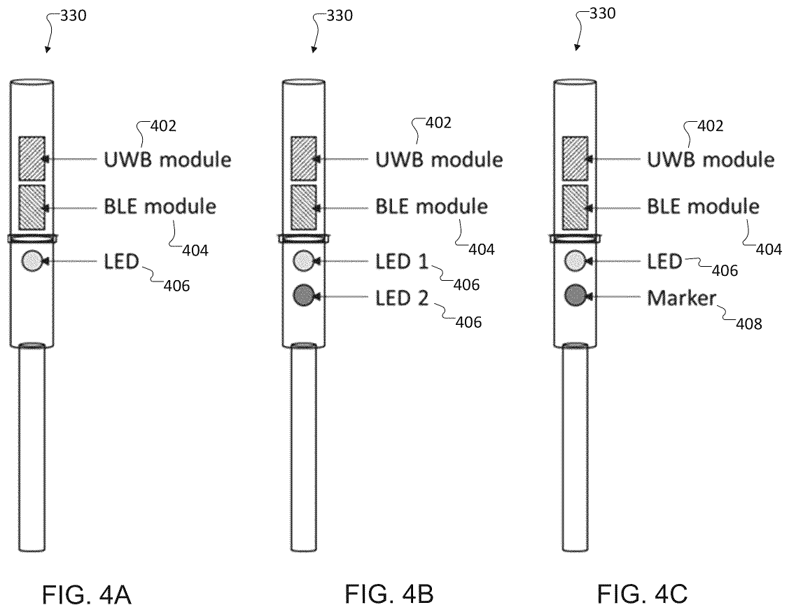

In some embodiments, the anchors 330 are encased in, or mounted to, one or more structures (e.g., a pole) that can be easily installed around the service area 302. It is noted that terms “anchors,” “anchor poles,” and “beacon poles” are used interchangeably in this disclosure. FIGS. 4A through 4C show a few different configurations for the anchor 330 according to embodiments of the present disclosure. As shown in FIGS. 4A through 4C, the anchor 330 includes a UWB module 402 that enables UWB communication with the electronic device 310 and the robot 320. The anchor 330 also includes a secondary RF module 404 that can be used to create a secondary wireless network for communication of data and commands between the anchors 330 and the tags 340. Consequently, the devices containing the tags 340 (e.g., the electronic device 310 and the robot 320) also contain compatible RF modules. In one embodiment, the secondary RF modules 404 are Bluetooth Low Energy (BLE) modules. Other embodiments may employ a secondary Wi-Fi network for the communication of data and commands between the anchors 330 and the tags 340.

Additionally, the anchors 330 can have one or more LEDs 406, as shown in FIGS. 4A through 4C. The LED(s) 406 can be used to show a power ON or OFF state of the anchor 330. Additionally, the LED(s) 406 may be used to distinguish one anchor 330 from another, for example using different colors that impose sequence ordering for the anchors 330. In some embodiments, if at least two LEDs 406 are used, one of the LEDs 406 could be used to indicate the power ON or OFF state of the anchor 330, and the second LED 406 could be used to emit a particular color designated for the anchor 330 during the setup process. When the anchor 330 contains a single LED 406, the color of the LED 406 could be used to associate a specific anchor 330, and the power ON or OFF state of the anchor 330 is indicated by the ON or OFF state of the LED 406, irrespective of the color. Additionally, or alternatively, in some embodiments, a marker 408 (shown in FIG. 4C) may be used to designate the anchor numbers. The marker 408 may be attached to the anchor poles during the initial setup. Examples of such markers 408 include (but are not limited to) stickers of numbers, colors, sets of dots, and the like.

In addition to indicating the power state and anchor numbers, the LED(s) 406 may also be used to indicate if the anchor 330 is placed at a non-optimum position so that the user may move the anchor 330 to a better location. A non-optimum position is any location in the service area 302 where there is a potential for significant loss of the received signal strength transmitted from one or more locations in the service area 302, including from the locations of other anchors 330. The loss in the received signal strength could be caused by several factors, including (but not limited to) occlusions between the receiver and transmitter, such as buildings, trees, garden ornaments, and the like. Non-optimum locations could also arise as a result of large separation between the transmitter and the receiver, for example, if only a few anchors 330 are sparsely placed over a large lawn area.

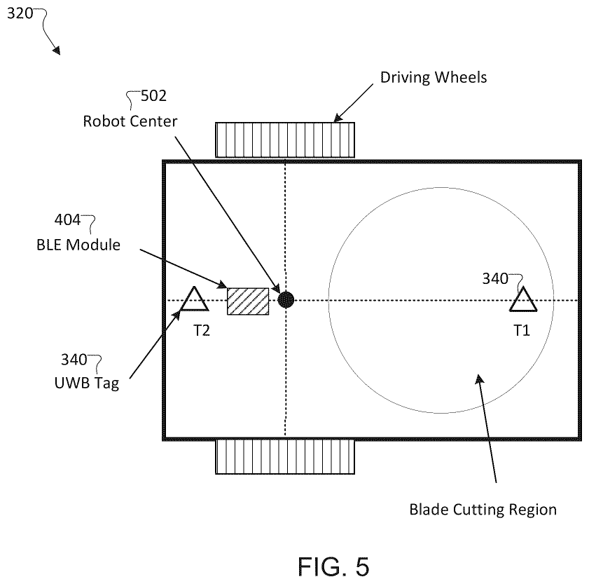

FIG. 5 illustrates an example diagram of a UWB based robot 320 according to embodiments of the present disclosure. As shown in FIG. 5, the robot 320 includes a point identified as the robot center 502. The robot center 502 is often defined as the middle point of its driving wheel axle. The robot 320 also includes one or more UWB tags 340. There is no strict limitation on the number or placement of the tags 340. The location of each tag 340, the relative displacements (Δx,Δy) of the tag 340 from the robot center 502, and robot orientation information can be used to determine the location of the robot center 502. In some embodiments, two UWB tags 340 can be used on the robot 320 to obtain two location measurements (T1 and T2). In turn, these measurements can be used to obtain the location of the robot center 502 and UWB-based robot orientation measurement. This UWB-based measurement can then be fused with orientation from an IMU or other sensors to further improve localization accuracy.

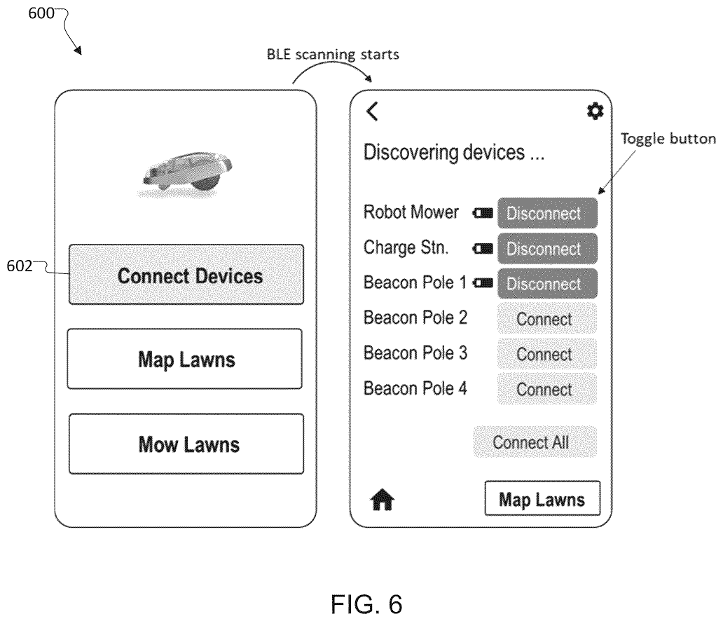

FIG. 6 illustrates an example user interface 600 for discovering and connecting the system devices according to embodiments of the present disclosure. As shown in FIG. 6, the user interface 600 can be displayed on the electronic device 310, and allows the user to discover and connect the robot 320, the charging station 308, and the anchors 330.

In some embodiments, the user may employ the electronic device 310 during the initial setup phase to monitor and visualize the self-localization and map generation. A BLE or Wi-Fi secondary wireless link can be used by the electronic device 310 for coordinating with the BLE modules 404 in the anchors 330 and tags 340 for estimating the location from UWB ranging. This process is explained in greater detail below.

In one aspect of operation, the user clicks on a “Connect Devices” button 602 to connect the robot 320, the charging station 308, the anchors 330, and the electronic device 310 to a common wireless network. If the network is BLE, the electronic device 310 acts as the central device whereas the anchors 330, the charging station 308, and the robot 320 act as peripheral devices. When the user clicks on the “Connect Devices” button 602, the electronic device 310 starts scanning for the devices and discovers the devices via a special service UUID in the advertisement packets from the peripheral devices. The user can then connect the discovered devices via the user interface 600.

Once the anchors 330 are installed around the different zones, the self-localization process starts with the determination of a set of first four anchors 330. The anchors 330 in this set of the first four anchors 330 are required to be installed in a pre-determined orderly fashion such as a clockwise or counterclockwise fashion. Herein, the embodiments will be described as constraining the arrangement of the first four anchors in a counterclockwise fashion. Another constraint is that the four anchors in the set of first four anchors cannot be installed along a straight line, but rather form a quadrangle.

While these two simple constraints allow the algorithm to uniquely find a solution of the multilateration problem (e.g., using a least squares optimization), the constraints do not limit the applicability in practical situations. For example, as shown in the non-trivial scenario of multiple anchors 330 around the house 304b with paved roads in FIG. 3, a choice for the first four anchors 330 could be anchors 1, 2, 3, and 4 (henceforth referred to as A1, A2, A3, and A4 respectively).

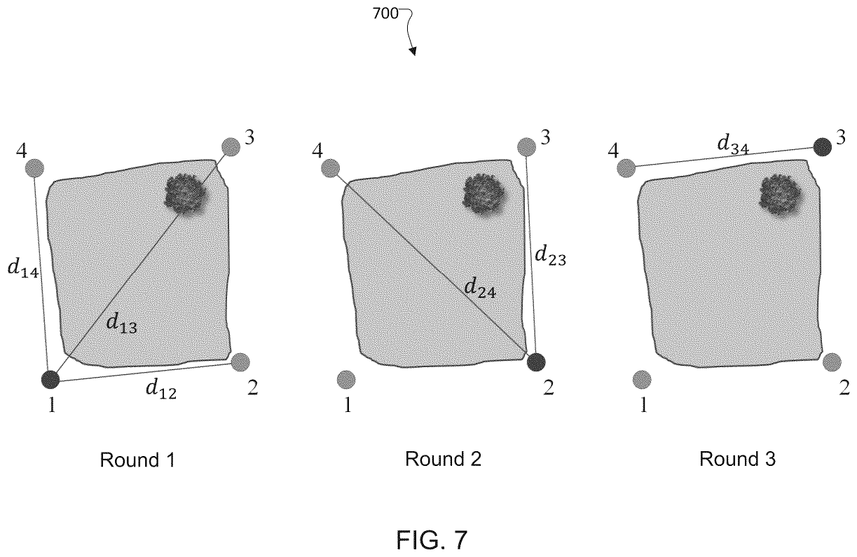

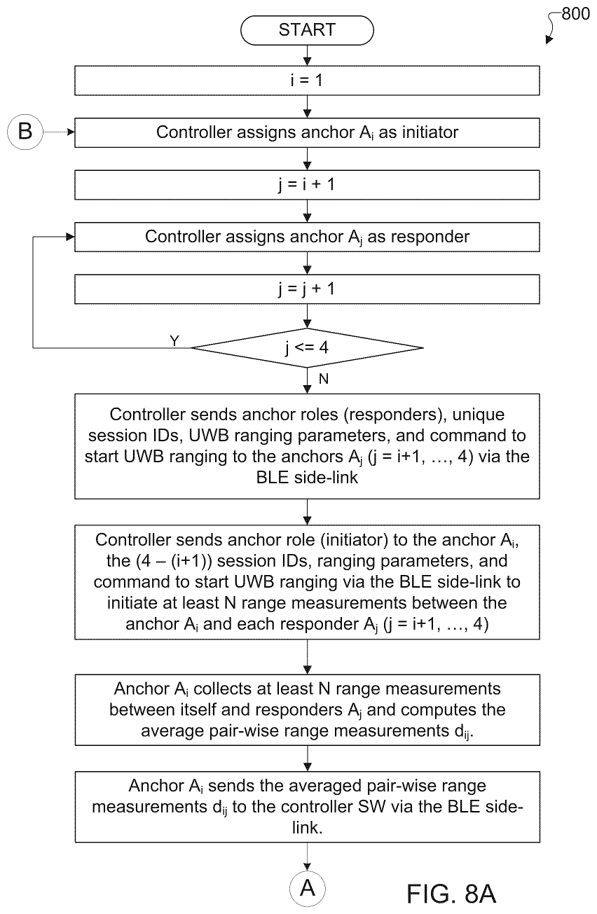

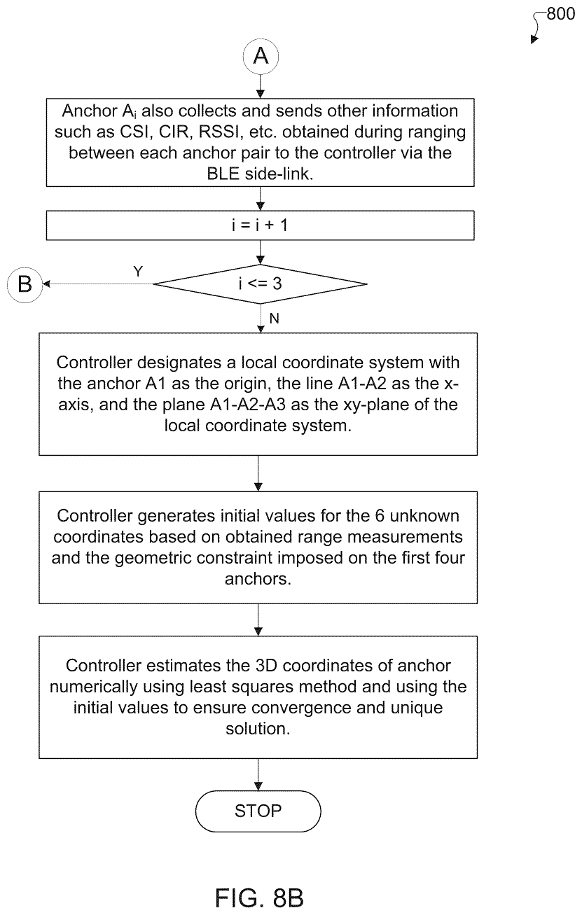

FIG. 7 illustrates a diagram 700 showing localization of the first four anchors 330 according to embodiments of the present disclosure. As shown in FIG. 7, the localization proceeds via three ranging rounds. In the first round, anchor A1 is set as the initiator while the other three anchors 330 are set as the responders. A number of UWB ranging measurements between each initiator-responder pair is obtained. The inter-anchor distances (distances between A1 and A2, A1 and A3, and A1 and A4) are obtained by taking an average or median of the collected measurements. In the second round, anchor A2 is set as the initiator and the inter-anchor distances between the anchors A2 and A3, and between the anchors A2 and A4 are obtained by taking a number of measurements followed by averaging or median filtering the collected measurements. Finally, in the third round, the distance between anchors A3 and A4 is measured by setting anchor A3 as the initiator, taking a number of measurements, and averaging or median filtering the collected measurements. The averaging or median filtering is performed to reduce the impact of small measurement errors. In each round, the measured inter-anchor distances are sent from the initiator to the controller for auto-positioning over Wi-Fi or BLE. The controller for auto-positioning could be implemented (and executed) either on the electronic device 310 or on the robot 320. FIGS. 8A and 8B illustrate a flowchart 800 of this process for auto-positioning of the first four anchors.

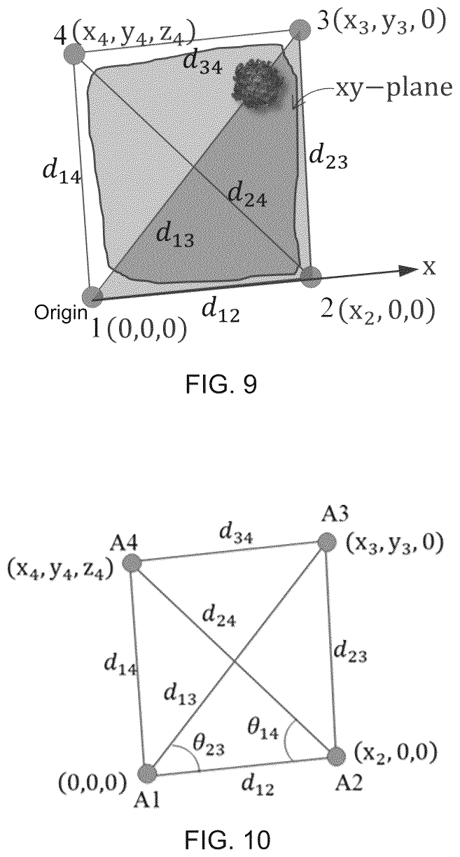

The controller creates a local reference frame by assigning the anchor A1 to be the origin, having coordinates (0, 0, 0), and assigning the line joining the anchors A1 and A2 as the x-axis of the reference system as shown in FIG. 9. Therefore, the location of A2 becomes (x₂, 0, 0) where x₂ is the unknown coordinate to be determined. Since a plane can be defined by three points, the controller assigns an x-y plane defined by the anchors A1, A2, and A3. Therefore, the location of anchor A3 can be represented as (x₃,y₃, 0) where x₃ and y₃ are the unknown coordinates to be determined. The location of anchor A4 can then be represented as (x₄, y₄, z₄) where x₄, y₄ and z₄ are the unknown coordinates to be determined. Using this formulation, there are six unknown variables to determine from six distance measurements. By relating the distances with the coordinates, six non-linear equations with six unknowns can be obtained. It is possible to solve for the unknowns numerically using a non-linear least squares method, such as a Gauss-Newton or Levenberg-Marquardt algorithm.

In order to obtain a unique and desirable solution (so that the algorithm does not get stuck in a local minima), a problem-specific starting (initial) point is determined that relies on the constraints discussed earlier: the first four anchors 330 should be installed in a counterclockwise (or clockwise) fashion starting with the first anchor 330 (A1) and forming a quadrangle. The initialization strategy for the algorithm is as follows, with reference to the variables shown in FIG. 10: knowns: d₁₂, d₁₃, d₁₄, d₂₃, d₂₄, d₃₄; unknowns: x₂, x₃, x₄, y₃, y₄, z₄:

Let the initial value of x₂ be x₂_{ᵢₙᵢₜ}=d₁₂

Let θ₂₃ be the angle formed by the lines A1-A2 and A1-A3 at the anchor A1.

Furthermore, let

$${θ}_{23} \approx {tan}^{- 1} ( \frac{{d}_{23}}{{d}_{12}} ) .$$

Then, compute the initial value of x₃ as x₃_{ᵢₙᵢₜ}=d₁₃ cos(θ₂₃) and the initial value of y₃ as y₃_{ᵢₙᵢₜ}=d₁₃ sin(θ₂₃).

Let θ₁₄ be the angle formed by the lines A2-A4 and A2-A1 at anchor A2.

Then, let

$${θ}_{14} \approx {tan}^{- 1} ( \frac{{d}_{14}}{{d}_{12}} ) .$$

Compute, the initial value of x₄ as x₄_{ᵢₙᵢₜ}=d₁₂−d₂₄ cos(θ₁₄) and the initial value of y₄ as y₄_{ᵢₙᵢₜ}=d₂₄ sin(θ₁₄).

Finally, the initial value for z₄ can be assigned randomly to a reasonable numerical value. This value is really the difference in the height of the anchor A4 and the plane A1-A2-A3. For example, z₄_{ᵢₙₜ}=U[−1, 1], where U represents uniform distribution.

The above initialization strategy for solving the least squares problem numerically relies on the geometrical constraints imposed on the anchor positions which makes it robust and effective.

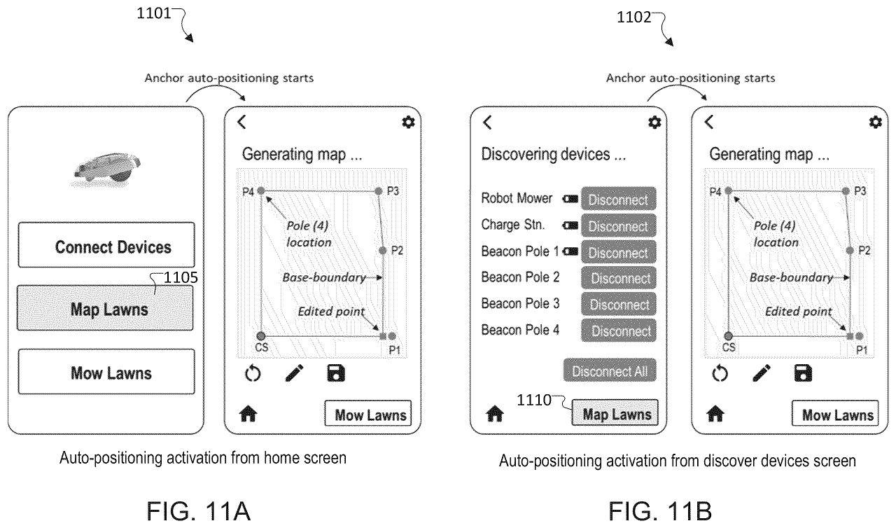

FIGS. 11A and 11B illustrate example user interfaces 1101-1102 showing activation of auto-positioning by the user according to embodiments of the present disclosure. As shown in FIGS. 11A and 11B, the user interfaces 1101-1102 allow the user to start anchor auto-positioning once all the devices are connected wirelessly. In the user interface 1101, the user can activate the start of anchor auto-positioning by clicking on the “Map Lawn” button 1105 on the home screen. In the user interface 1102, the user can activate the start of anchor auto-positioning by clicking on the “Map Lawns” button 1110 in the Discover devices screen. This option follows the BLE connection establishment with at least four anchors 330. Once the auto-positioning process finishes, the user can view the location of the anchors 330 and a base-boundary map on the user interface 1101-1102.

One of the factors that influences the accuracy of UWB range measurements is the LoS/NLoS condition between the pair of anchors 330 used for ranging. Ideally, there should not be any obstacles in the direct straight line path between the two anchors 330 (i.e., the LoS condition). When the LoS condition is present, there will be a strong and distinct peak in the received signal (characterized by the channel impulse response) that enables the controller to accurately determine the time-of-flight of the message and hence the distance between the pair of anchors 330. If there are obstacles between the pair of anchors 330 (i.e., the NLoS condition), radio messages may not travel from one anchor 330 to the other along a direct path. Instead, the radio messages may get reflected several times, bounce around and finally reach the destination along multiple paths. In such NLoS conditions, the overall strength of the received signal is weaker, and the secondary peaks corresponding to the several different paths may be stronger compared to the first peak (from the direct path), making it harder for the controller to accurately determine the time-of-flight along the direct path. The inaccuracy in determining the time-of-flight results in inaccurate range measurements. Since the first three anchors 330 define the reference frame, and the first four anchor locations are used to define the positions of other anchors 330 to extend the service area (if required), it is important to estimate the locations of these first four anchors 330 as accurately as possible.

As shown in FIG. 8B, the controller gathers other information, such as channel impulse response (CIR), channel state information (CSI), and received signal strength indicator (RSSI), for the initiator anchor 330 in each ranging round. Using such information, the controller can determine LoS/NLoS condition between each anchor pair and also the degree (or severity) of the NLoS condition. For example, if there are multiple peaks in the CSI, the controller determines that there are several paths indicative of a NLoS condition. Furthermore, the number of such peaks and the spread of energy among many peaks along with the RSSI can indicate the degree of severity. For example, the presence of multiple small peaks in the CSI can indicate severe scattering (and multipath).

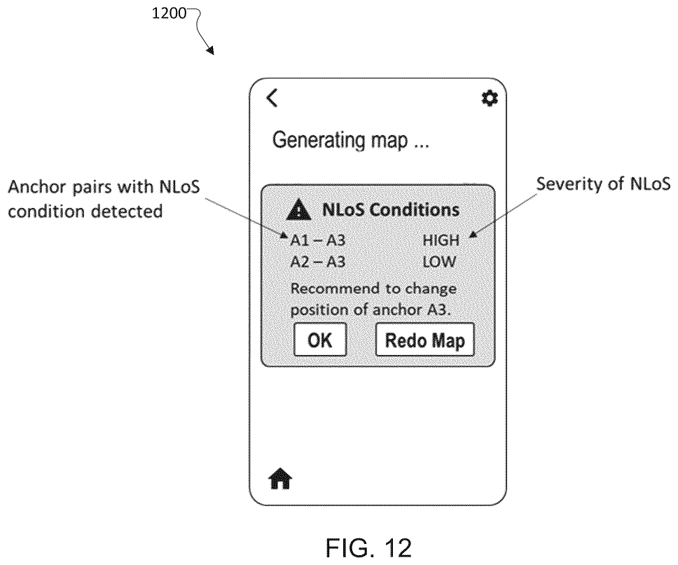

In some embodiments, the controller determines the severity of the NLoS conditions between the first four anchors 330 after the first auto-positioning session and notifies the user about such conditions along with the severity. For example, FIG. 12 illustrates a user interface 1200 that warns the user about a detected NLoS condition during auto-positioning, so that the user may change the position of the affected anchor and redo the anchor auto-positioning.

Frequently, it may not suffice to use only four anchors 330 to adequately define the (virtual) perimeters of the lawns and generate the blueprint of the different zones. For example, as show in FIG. 3, the juxtaposition of several service areas, pass-only areas, keep-out zones, and other obstacles may create undesirable NLoS conditions if only four anchors 330 are placed along the outer perimeter (i.e., Anchors 1, 2, 5, and 7). In such situations, several additional anchors 330 should be distributed (for example, Anchors 1 through 8 in FIG. 3) to cover and map all of the regions effectively. Furthermore, in other situations, the user's total mowing region may extend beyond the rated workable range of four anchors 330. In such cases, the user could extend the working coverage of the robot 320 by adding additional anchors 330.

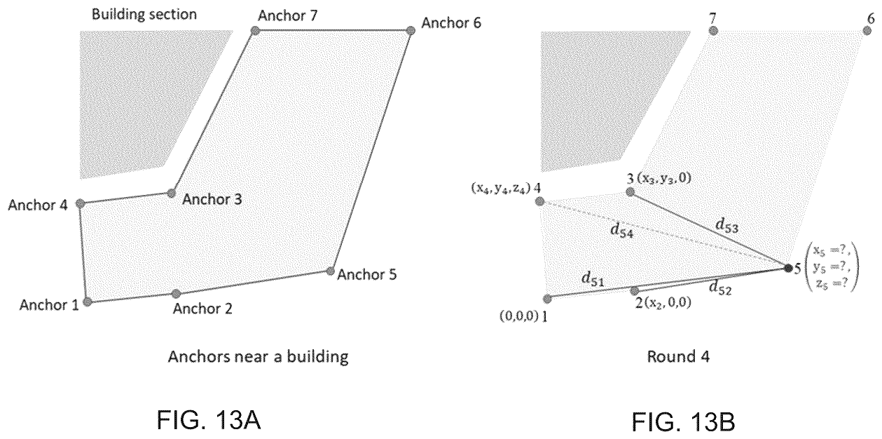

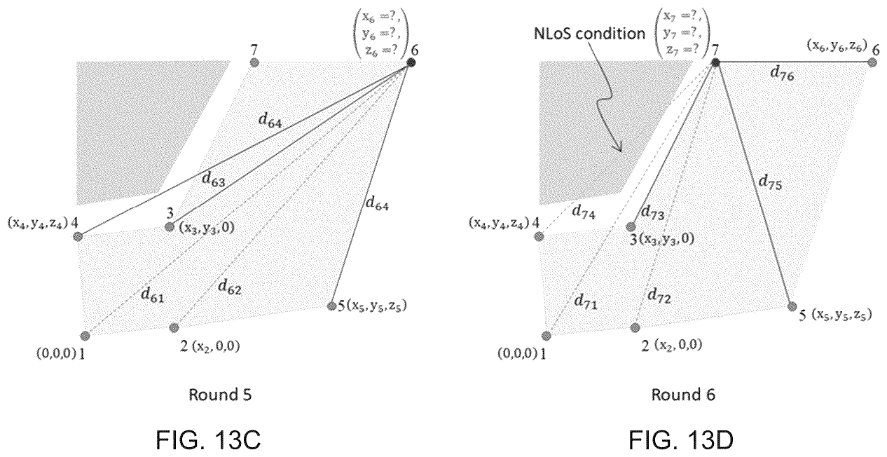

FIG. 13A through 13D illustrate an example of anchor auto-positioning of more than four anchors near a building according to embodiments of the present disclosure. As shown in FIG. 13A, seven anchors are installed around a mowing region (lawn) surrounding a building section. As described above, the first four anchors (Anchors 1 through 4) are chosen to form a quadrangle and arranged in counterclockwise fashion starting with Anchor 1. Since the first four anchors are in direct LoS of each other, the 3D positions of these anchors can be determined using three rounds of UWB ranging (Rounds 1 through 3) followed by the multilateration technique described above (as shown in FIGS. 8A and 8B).

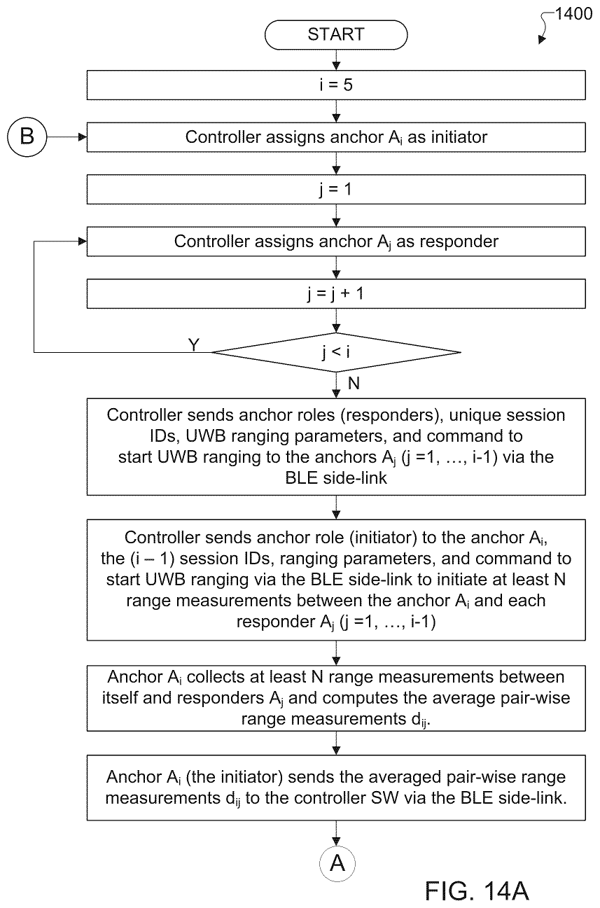

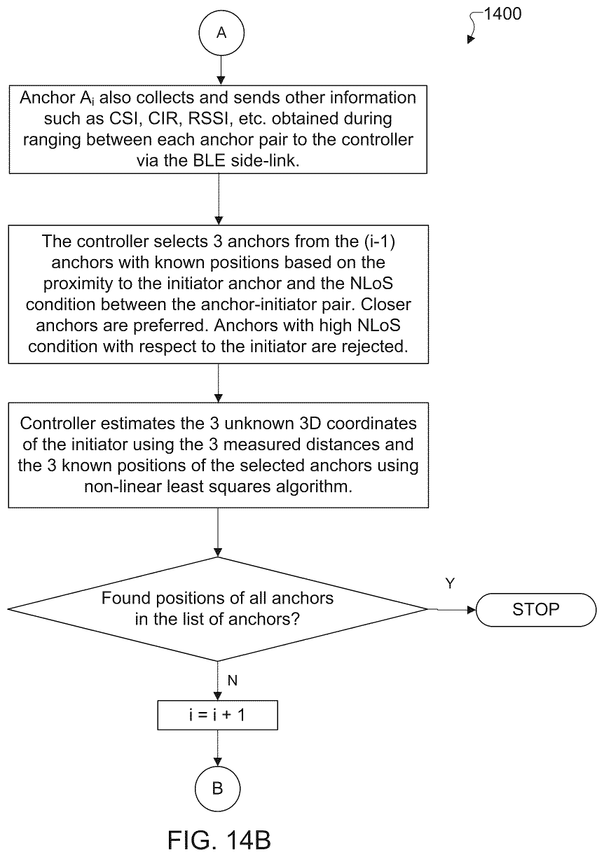

A process to progressively determine the locations of the additional anchors is illustrated in FIGS. 13B through 13D. After the positions of the first four anchors 330 are available, the controller progressively performs additional rounds of UWB ranging (Rounds 4 through 6) in which the controller selects an additional anchor from the group of anchors to determine its position. The controller becomes aware of these additional anchors when they are discovered during the BLE device scanning, which can be performed both during the initial installation process or added later (after the auto-positioning of the first four anchors). FIGS. 14A and 14B illustrate a flowchart 1400 of this process for determining locations of additional anchors.

In some embodiments, the selection of the next anchor 330 for auto-positioning is based on the order of the anchors 330 in the discovered devices list. The discovered devices list is stored by the controller in a memory of the electronic device 310. Additionally, the discovered devices list can be displayed in a user interface for viewing by the user, such as the user interface 600 shown in FIG. 6. The order of the devices in the list may be generated automatically by the controller based on pseudo-proximity of the anchors 330, as inferred from the RSSI of the secondary wireless communication channel (e.g., BLE or Wi-Fi), to the one or more anchors 330 whose positions are known to the controller. In some embodiments, the order of the devices can be rearranged by the user by overriding the system ordering.

In the example shown in FIG. 13A through 13D, suppose that the anchor auto-positioning order matches the anchor numbers depicted in the figures. Therefore, the positions of Anchors 5, 6, and 7 would be determined in that order in Rounds 4, 5 and 6, as shown in FIG. 13B, FIG. 13C, and FIG. 13D, respectively.

In each round, the selected anchor (i.e., Anchor 5 in Round 4, Anchor 6 in Round 5, and Anchor 7 in Round 6) is set as the initiator, and all other anchors whose positions have been determined (i.e., Anchors 1, 2, 3, 4 in Round 4; Anchors 1, 2, 3, 4, 5 in Round 5; and Anchors 1, 2, 3, 4, 5, 6 in Round 6) are set as responders. Then, UWB ranging between the initiator and each of the responders is initiated to measure the range and other information (e.g., CIR, CSI, RSSI, etc.) to determine the severity of NLoS between each of the initiator-responder pairs.

Once all the information is available to the controller in a round, the controller selects three responders with known positions based on the measured proximity and the LoS/NLoS conditions. For example, in Round 4 (FIG. 13B), the responders 2, 3, and 1 are selected because d₅₄>d₅₁>d₅₃>d₅₂ for determining the location of Anchor 5. Similarly, in Round 5 (FIG. 13C), responders 3, 5 and 4 are chosen because d₆₁>d₆₂>d₆₄>d₆₅>d₆₃-However, in Round 6 (FIG. 13D), responders 6, 3, and 5 are chosen to determine the position of Anchor 7. Anchor 5 is chosen over Anchor 4 even though d₇₅>d₇₄ because the building section between Anchors 4 and 7 results in a severe NLoS condition between the two anchors.

To compute the 3D position of the new anchor 330 from the three distances to the chosen anchors 330 with known (already estimated) positions, the controller forms three non-linear equations relating the unknown coordinates with the three distances and the known coordinates, and solves the problem numerically using a non-linear least squares method such as a Gauss-Newton or Levenberg-Marquardt algorithm. Similar to the solution of the coordinates for the first four anchors 330, the non-linear least squares method benefits from a good starting point (initialization of the unknown variables) for speedy convergence and obtaining the solution. An initialization strategy based on the geometry of the problem can be used to initialize the unknown variables, if the first four anchors 330 are visible (i.e., LoS condition or negligible NLoS condition) from the perspective of the new anchor 330 whose location is to be estimated. Note that it is not required that any of the first four anchors 330 be in the set of the three anchors used for the non-least squares estimation. One such initialization strategy will now be described.

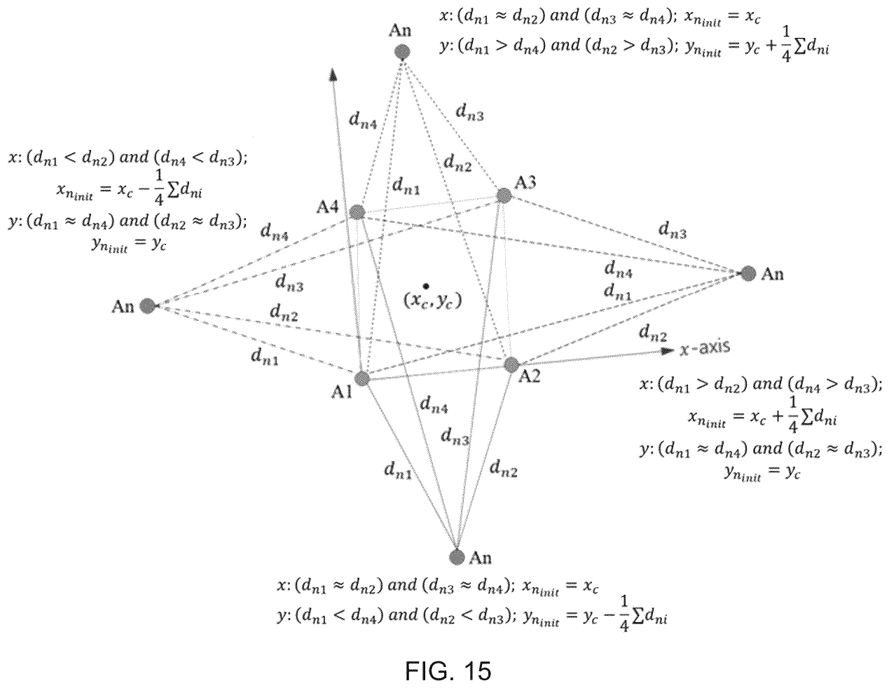

In some embodiments, the initialization strategy roughly estimates the dominant direction of the new anchor 330 with respect to the cluster of the first four anchors 330. FIG. 15 illustrates the initialization strategy according to embodiments of the present disclosure. As shown in FIG. 15, An represents the new anchor 330, which represents an arbitrary anchor number greater than or equal to five. In FIG. 15, the new anchor An is shown in four arbitrary possible locations. In reality, the anchor An could be located almost anywhere outside the quadrangle formed by the first four anchors A1, A2, A3, and A4. The measurements dₙ₁, dₙ₂, dₙ₃, and dₙ₄ are shown for each of the four shown possible locations of the anchor An. These measurements represent the measured UWB distance between the anchor An and the first four anchors A1, A2, A3, and A4 respectively. The 2D coordinates (x_{c}, y_{c}) is the centroid (2D) of the first four anchor coordinates.

The initial value of the x-coordinate (xₙ_{ᵢₙᵢₜ}) of the anchor An can be determined according to the following:
If (dₙ₁>dₙ₂) && (dₙ₄>dₙ₃), then

xₙ_{ᵢₙᵢₜ}=x_{c}+¼Σᵢ₌₁⁴dₙᵢ
else if (dₙ₁<dₙ₂) && (dₙ₄<dₙ₃), then

xₙ_{ᵢₙᵢₜ}=x_{c}−¼Σₙ₌₁⁴dₙᵢ
else

xₙ_{ᵢₙᵢₜ}=x_{c}

Similarly, the initial value of the y-coordinate (yₙ_{ᵢₙᵢₜ}) of the anchor An can be determined according to the following:
If (dₙ₁>dₙ₄) && (dₙ₂>dₙ₃), then

yₙ_{ᵢₙᵢₜ}=y_{c}+¼Σᵢ₌₁⁴dₙᵢ
else if (dₙ₁<dₙ₄) && (dₙ₂<dₙ₃), then

yₙ_{ᵢₙᵢₜ}=y_{c}−¼Σᵢ₌₁⁴dₙᵢ
else

yₙ_{ᵢₙᵢₜ}=y_{c}

The initial value of the z-coordinate (zₙ_{ᵢₙᵢₜ}) of the anchor An can be obtained by averaging the z-coordinates of the three anchors 330 selected for solving the non-linear least squares problem based on the proximity of the anchors 330 to the anchor An and the LoS/NLos condition, such as by the following:

zₙ_{ᵢₙᵢₜ}=⅓Σᵢ₌₁³z_{Ai}

If the any one or more of the first four anchors 330 (A1, A2, A3, and A4) are not visible (i.e., severe NLoS condition or beyond the specified UWB ranging distance) from the perspective of the new anchor An, then the initial values of the x-coordinate and the y-coordinate of the new anchor may be assigned, similar to the initial value of the z-coordinate, as the mean (centroid) of the x- and y-coordinates of the three anchors 330 selected.

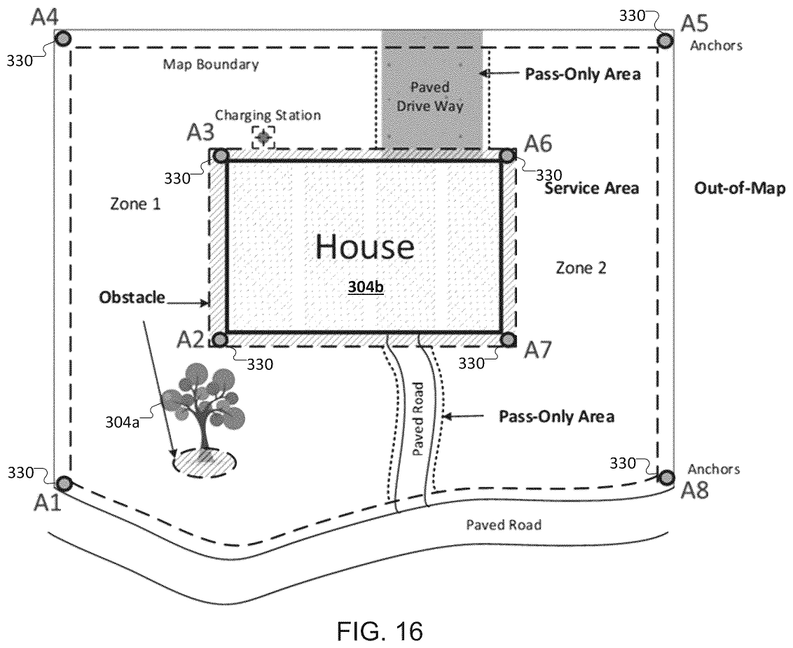

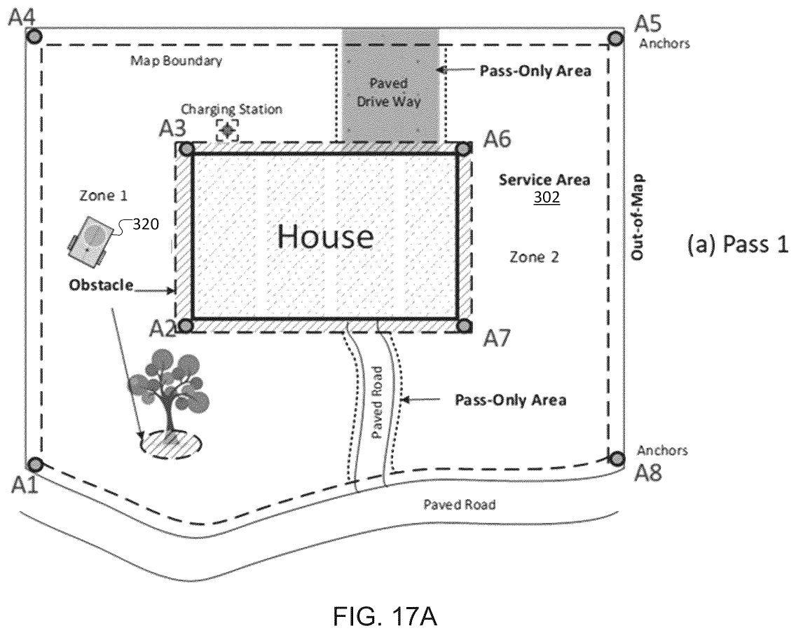

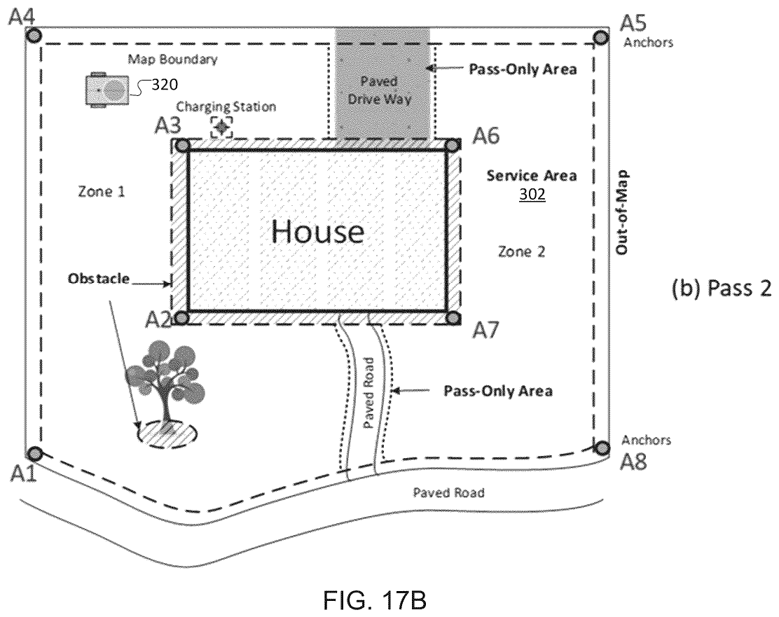

As described earlier, when a new anchor 330 with unknown position is added to the group of anchors 330 with known positions, at least three anchors 330 are needed to determine the position of the new anchor 330. The at least three anchors 330 have known positions and are in LoS or not significantly obstructed with respect to the new anchor 330. For example, FIG. 16 illustrates an example of auto-positioning using the strategy described above according to embodiments of the present disclosure. As shown in FIG. 16, if the anchors A1 and A2 are significantly obstructed by the house 304b and tree 304a from the position of anchor A6 (so as to cause a significant NLoS condition), then the estimation of anchor A6's position may be impossible or inaccurate even if the positions of anchors A1, A2, A3, and A4 are known. Therefore, to determine the positions of extended anchors, such as anchor A6, another progressive strategy that includes the robot 320 during the anchor self-localization stage may be performed, as shown in FIGS. 17A and 17B.

FIGS. 17A and 17B illustrate an example progressive estimation of anchor locations in complex scenarios using the robot, according to embodiments of the present disclosure. As shown in FIG. 17A, the positions of the anchors A1, A2, A3, and A4 may be estimated using the four-anchor auto-positioning method described previously. Then, the position of the robot 320 that is in the LoS of these four anchors 330 may be estimated in the local coordinate system with anchor A1 as the origin. During this mode, the UWB module in the robot 320 should be instantiated as a UWB tag 340. This constitutes Pass 1 shown in FIG. 17A. Note that the position of the robot 320 may also be determined in a single step in Pass 1.

Then, in Pass 2 as shown in FIG. 17B, the robot 320 may be steered to a position in the service area such that the robot 320 and two other anchors 330 with known positions (e.g., anchors A3 and A4) are in LoS or near-LoS with respect to the new anchor 330 (e.g., anchor A6). The new position of the robot 320 can easily be determined either from the anchors A1, A2, A3, and A4 or from the wheel encoder and IMU sensor data of the robot 320. Then, the UWB module in the robot 320 may be re-configured as a UWB anchor (with known position). Now, the 3D position of the anchor A6 can be computed by first measuring the pair-wise distances A6-A4, A6-A3, and A6-robot, and then determining the three unknown coordinates from the three distance measurements. Note that the electronic device 310 may also be used instead of the robot 320 in this strategy.

In some embodiments, the progress of the anchor self-localization process is shown to the user via the user interface of the electronic device 310 (e.g., smartphone). The display can show text, graphics, or a combination of both to effectively present the information to the user. For example, in each round, the user interface could show which anchor 330 is acting as the initiator and which anchors 330 are acting as responders, and whether a UWB ranging session is active between the initiator anchor 330 and the one or more responder anchors 330. Additionally, the display can also indicate which ranging round is being performed, how many rounds are left, and the positions of the anchors 330 (following position estimation).

The previous embodiments described how three anchors 330 with known positions can be selected to determine the position of a new anchor 330. In some embodiments, a greedy approach can be adopted in which more than three anchors with known positions are selected, if available. In these embodiments, anchors 330 (with known positions) are rejected if they exhibit a medium to severe NLoS condition from the perspective of the new anchor 330, irrespective of their distances as long as their distances are within the specified UWB ranging working distance.

In other embodiments, if only two anchors 330 with known positions are visible (including the case when the robot 320 is used as an anchor 330 from the perspective of the new anchor 330 whose position is to be determined), the algorithm still proceeds to compute the location of the new anchor 330. In such scenarios, the algorithm solves for the 2D (x and y) spatial coordinates from the two distance measurements to the two visible anchors 330 from the new anchor 330. Once the 2D coordinates have been estimated, the algorithm could set the z-coordinate of the new anchor 330 to be equal to the z-coordinate of the nearest anchor 330 whose 3D location has been previously estimated. Or the algorithm could set the z-coordinate of the new anchor 330 to be equal to a weighted average of the z-coordinates of the anchors 330 in the neighborhood of the new anchor 330. In some embodiments, a more sophisticated algorithm could be used to extrapolate the z-coordinate of the new anchor 330 based on the z-coordinates of other anchors 330 in the neighborhood and their distances from the new anchor 330.

In some embodiments, instead of progressively adding one new anchor 330 each time starting with the initial set of four anchors 330, auto-positioning can be performed across several clusters (groups) of anchors 330, with at least two anchors 330 common between neighboring clusters. Initially, each cluster will have its own reference frame and position of the anchors 330 in the cluster computed in its own reference frame. Once auto-positioning has completed for all anchors 330 (across multiple groups), one of the groups could be assigned as the parent group. Then, the transformation matrix from one group to the other group in the immediate neighborhood can be computed using the common anchors 330 in the two groups. Thus, all anchor positions in all groups can be transformed to the reference frame of the parent group resulting in a single consolidated reference frame and the positions of all the anchors 330 computed in the single reference frame.

Although FIGS. 3 through 17B illustrate an example of a system 300 in which UWB beacon pole locations can be determined for extended service areas of a robot and related details, various changes may be made to FIGS. 3 through 17B. For example, while the robot 320 is generally described as a UWB based autonomous robot, the procedure described in this disclosure can be applied to other RF sensors, alone or together with UWB sensors. Also, various components in FIGS. 3 through 17B could be combined, further subdivided, or omitted and additional components could be added according to particular needs. In addition, various operations in FIGS. 3 through 17B could overlap, occur in parallel, occur in a different order, or occur any number of times.

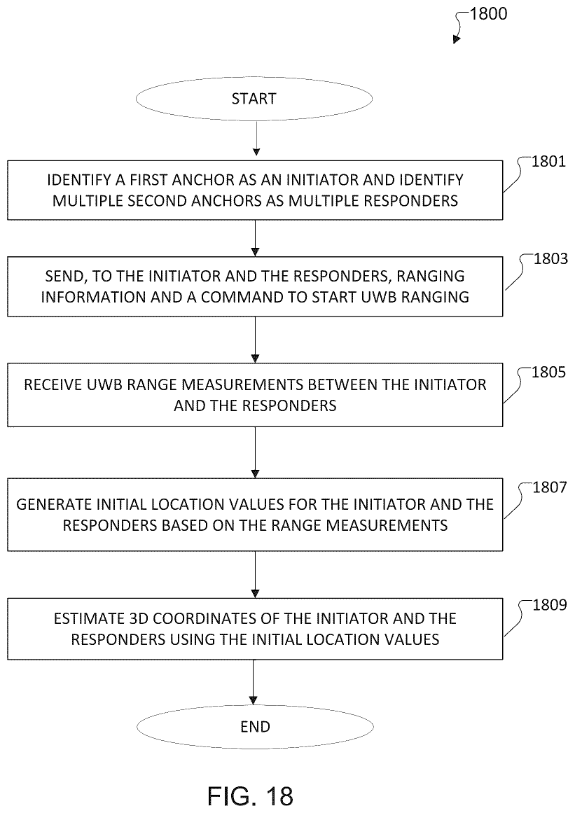

FIG. 18 illustrates a flow chart of a method 1800 for determining UWB beacon pole locations for extended service areas of a robot according to embodiments of the present disclosure, as may be performed by an electronic device (e.g., the electronic device 310). The embodiment of the method 1800 shown in FIG. 18 is for illustration only. One or more of the components illustrated in FIG. 18 can be implemented in specialized circuitry configured to perform the noted functions, or one or more of the components can be implemented by one or more processors executing instructions to perform the noted functions.

As illustrated in FIG. 18, the method 1800 begins at step 1801. At step 1801, a first anchor of a plurality of anchors is identified as an initiator, and multiple second anchors of the plurality of anchors are identified as multiple responders. The plurality of anchors is located in a service area to be traversed by a robot. This could include, for example, the electronic device 310 identifying an initiator and multiple responders among the anchors A1, A2, A3, and A4, such as described with respect to FIGS. 7, 8A, and 8B.

At step 1803, ranging information and a command to start UWB ranging is sent to the initiator and the responders via a wireless side-link. This could include, for example, the electronic device 310 sending ranging information and a command to start UWB ranging to the initiator and the responders via a BLE or Wi-Fi side-link, such as described with respect to FIGS. 8A and 8B.

At step 1805, pair-wise range measurements representing UWB range measurements between the initiator and the responders are received from the initiator via the wireless side-link. The pair-wise range measurements represent UWB range measurements between the initiator and the responders. This could include, for example, the initiator collecting the range measurements between itself and the responders, and then sending the range measurements to the electronic device 310, such as described with respect to FIGS. 8A and 8B.

At step 1807, initial location values for the initiator and the responders are generated based on the pair-wise range measurements and one or more geometric constraints imposed on the initiator and the responders. This could include, for example, the electronic device 310 generating initial location values for the initiator and the responders based on the pair-wise range measurements and one or more geometric constraints (e.g., the anchors are arranged in a quadrangle in a counter-clockwise sequence), such as described with respect to FIGS. 7, 8A, and 8B.

At step 1809, 3D coordinates of the initiator and the responders are estimated using the initial location values. In some embodiments, the 3D coordinates of the initiator and the responders are estimated using a least-squares method. This could include, for example, the electronic device 310 estimating the 3D coordinates of the initiator and the responders using the initial location values, such as described with respect to FIGS. 7 through 10.

Although FIG. 18 illustrates one example of a method 1800 for determining UWB beacon pole locations for extended service areas of a robot, various changes may be made to FIG. 18. For example, while shown as a series of steps, various steps in FIG. 18 could overlap, occur in parallel, occur in a different order, or occur any number of times.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
identifying a first anchor of a plurality of anchors as an initiator and identifying multiple second anchors of the plurality of anchors as multiple responders, the plurality of anchors located in a service area to be traversed by a robot;
sending, to the initiator and the responders via a wireless side-link, ranging information and a command to start ultra-wideband (UWB) ranging;
receiving, from the initiator via the wireless side-link, pair-wise range measurements representing UWB range measurements between the initiator and the responders;
generating initial location values for the initiator and the responders based on the pair-wise range measurements and one or more geometric constraints imposed on the initiator and the responders; and
estimating 3D coordinates of the initiator and the responders using the initial location values.

2. The method of claim 1, further comprising:
determining that an additional anchor is in a severe non-line-of-sight (NLoS) condition;
determining a location of the robot in the service area;
identifying the robot as a responder and identifying some of the plurality of anchors as either a responder or an initiator; and
performing the UWB ranging again to estimate a location of the additional anchor.

3. The method of claim 1, further comprising:
receiving, from the initiator via the wireless side-link, channel information obtained by the initiator during the UWB range measurements between the initiator and the responders, the channel information comprising at least one of: Channel Impulse Response (CIR), Channel State Information (CSI), Received Signal Strength Indicator (RSSI).

4. The method of claim 3, further comprising:
determining, based on the channel information, if one or more anchors of the plurality of anchors are in a severe non-line-of-sight (NLoS) condition such that accuracy of range measurement is affected; and
sending a user notification to move the one or more anchors to a new position.

5. The method of claim 1, wherein the wireless side-link comprises a Bluetooth Low Energy (BLE) or Wi-Fi connection.

6. The method of claim 1, wherein the 3D coordinates of the initiator and the responders are estimated using a least-squares method.

7. The method of claim 1, wherein sending, to the initiator and the responders via the wireless side-link, the ranging information comprises:
sending, to the initiator, an initiator anchor role, unique session IDs of each of the responders, and one or more UWB ranging parameters; and
sending, to each of the responders, a responder anchor role, a unique session ID corresponding to that responder, and the one or more UWB ranging parameters.

8. The method of claim 1, wherein the one or more geometric constraints comprise:
the anchors form a quadrangle; and
the anchors are arranged in the quadrangle in a counter-clockwise sequence.

9. A device comprising:
a transceiver; and
a processor operably connected to the transceiver, the processor configured to:
identify a first anchor of a plurality of anchors as an initiator and identify multiple second anchors of the plurality of anchors as multiple responders, the plurality of anchors located in a service area to be traversed by a robot;
send, to the initiator and the responders via a wireless side-link, ranging information and a command to start ultra-wideband (UWB) ranging;
receive, from the initiator via the wireless side-link, pair-wise range measurements representing UWB range measurements between the initiator and the responders;
generate initial location values for the initiator and the responders based on the pair-wise range measurements and one or more geometric constraints imposed on the initiator and the responders; and
estimate 3D coordinates of the initiator and the responders using the initial location values.

10. The device of claim 9, wherein the processor is further configured to:
determine that an additional anchor is in a severe non-line-of-sight (NLoS) condition;
determine a location of the robot in the service area;
identify the robot as a responder and identifying some of the plurality of anchors as either a responder or an initiator; and
perform the UWB ranging again to estimate a location of the additional anchor.

11. The device of claim 9, wherein the processor is further configured to:
receive, from the initiator via the wireless side-link, channel information obtained by the initiator during the UWB range measurements between the initiator and the responders, the channel information comprising at least one of: Channel Impulse Response (CIR), Channel State Information (CSI), Received Signal Strength Indicator (RSSI).

12. The device of claim 11, wherein the processor is further configured to:
determine, based on the channel information, if one or more anchors of the plurality of anchors are in a severe non-line-of-sight (NLoS) condition such that accuracy of range measurement is affected; and
send a user notification to move the one or more anchors to a new position.

13. The device of claim 9, wherein the wireless side-link comprises a Bluetooth Low Energy (BLE) or Wi-Fi connection.

14. The device of claim 9, wherein the 3D coordinates of the initiator and the responders are estimated using a least-squares method.

15. The device of claim 9, wherein to send, to the initiator and the responders via the wireless side-link, the ranging information, the processor is further configured to:
send, to the initiator, an initiator anchor role, unique session IDs of each of the responders, and one or more UWB ranging parameters; and
send, to each of the responders, a responder anchor role, a unique session ID corresponding to that responder, and the one or more UWB ranging parameters.

16. The device of claim 9, wherein the one or more geometric constraints comprise:
the anchors form a quadrangle; and
the anchors are arranged in the quadrangle in a counter-clockwise sequence.

17. A non-transitory computer readable medium comprising program code that, when executed by a processor of a device, causes the device to:
identify a first anchor of a plurality of anchors as an initiator and identify multiple second anchors of the plurality of anchors as multiple responders, the plurality of anchors located in a service area to be traversed by a robot;
send, to the initiator and the responders via a wireless side-link, ranging information and a command to start ultra-wideband (UWB) ranging;
receive, from the initiator via the wireless side-link, pair-wise range measurements representing UWB range measurements between the initiator and the responders;
generate initial location values for the initiator and the responders based on the pair-wise range measurements and one or more geometric constraints imposed on the initiator and the responders; and
estimate 3D coordinates of the initiator and the responders using the initial location values.

18. The non-transitory computer readable medium of claim 17, wherein the program code, when executed by the processor, further causes the device to:
determine that an additional anchor is in a severe non-line-of-sight (NLoS) condition;
determine a location of the robot in the service area;
identify the robot as a responder and identifying some of the plurality of anchors as either a responder or an initiator; and
perform the UWB ranging again to estimate a location of the additional anchor.

19. The non-transitory computer readable medium of claim 17, wherein the program code, when executed by the processor, further causes the device to:
receive, from the initiator via the wireless side-link, channel information obtained by the initiator during the UWB range measurements between the initiator and the responders, the channel information comprising at least one of: Channel Impulse Response (CIR), Channel State Information (CSI), Received Signal Strength Indicator (RSSI).

20. The non-transitory computer readable medium of claim 19, wherein the program code, when executed by the processor, further causes the device to:
determine, based on the channel information, if one or more anchors of the plurality of anchors are in a severe non-line-of-sight (NLoS) condition such that accuracy of range measurement is affected; and
send a user notification to move the one or more anchors to a new position.
